(19) United States
(12) Patent Application Publication
(10) Pub. No.: US 2012/0157701 A1
(43) Pub. Date: Jun. 21, 2012

(54) PROCESS FOR PREPARING SILOXY CARBOXYLATES

(75) Inventors: Martin Gärtner, Worms (DE); Jochen Petzoldt, Weisenheim am Berg (DE)

(73) Assignee: BASF SE, Ludwigshafen (DE)

(21) Appl. No.: 13/329,947

(22) Filed: Dec. 19, 2011

Related U.S. Application Data
(60) Provisional application No. 61/424,687, filed on Dec. 20, 2010.

(51) Int. Cl. C07F 7/18

(52) U.S. Cl. 556/440

(57) ABSTRACT

A process for preparing siloxy carboxylates is characterized by reaction of C₂-C₁₀-monocarboxylic acids with halosiloxanes of the general formula (I),

Hal-(SiR₂—O)ₓ—SiR₃ (I)

in which
Hal is the same or different and is fluorine, chlorine, bromine or iodine,
R is hydrogen, C₁-C₁₀-alkyl or C₆-C₁₄-aryl and
x is an integer from 1 to 20,
to form hydrogen halide in the presence of an auxiliary base, in which the auxiliary base forms, with the hydrogen halide, a salt which forms two immiscible phases with the siloxy carboxylate or the solution of the siloxy carboxylate in a suitable solvent and is removed by a liquid-liquid separation. The process enables simple and economically viable preparation of siloxy carboxylates.

The invention relates to a process for preparing silylated monocarboxylic acids by converting monocarboxylic acids in the presence of an auxiliary base.

The silylation of carboxylic acids is known in the literature. For instance, A. Shihada et al. disclose, in Z. Naturforsch. B 1980, 35, 976-980, the reaction of acetic acid with trimethylchlorosilane in diethyl ether with addition of diethylamine. V. F. Mironov et al. describe, in Chem. Heterocycl. Compd. 1966, 2, 334-337, the silylation of substances including methacrylic acid, likewise with trimethylchlorosilane in the presence of N,N-diethylaniline as an auxiliary base in diethyl ether. A disadvantage of these processes is the formation of voluminous hydrochloride precipitates which are difficult to filter and lead to yield losses in the filtration. An economically attractive regeneration of the auxiliary base is made difficult by the complicated solids handling.

The silylation of acrylic acid with hexamethyldisilazane is described by V. I. Rakhlin et al. in Russ. J. Org. Chem. 2004, 40. The reaction is disadvantageous since a continuous removal of the ammonia released is required. Moreover, the process requires long reaction times at elevated temperatures and affords only moderate yields.

The preparation of trimethylsilyl carboxylates is likewise described by C. Palermo in Synthesis 1981, 809-811. The carboxylic acid is reacted with N-trimethylsilyl-2-oxazolidone in halogenated solvents such as carbon tetrachloride or dichloromethane. This reaction route is not very practicable for industrial use, since the use of a halogenated solvent is problematic. Furthermore, the synthesis is costly, since the preparation of the silylating reagent is additionally necessary. The 2-oxazolidone is removed from the product by costly and inconvenient crystallization and filtration.

The synthesis of this silylating reagent is also disclosed in Synth. Commun. 1982, 12, 225-230 by Banerji et al. The reaction with the carboxylic acid gives rise to imidazole as a by-product, which has to be removed from the product by filtration with acceptance of yield losses.

Another preparation route is described by Y.-F. Du et al. in J. Chem. Res. Synop. 2004, 3, 223-225. This discloses the reaction of sodium acetate with trimethylchlorosilane in solvents such as diethyl ether, PEG-400 or benzene. The reactant used is the sodium salt of the carboxylic acid, which first has to be prepared and dried carefully. As a result, the synthesis gives rise to sodium chloride as a by-product, which has to be filtered off. WO 2003/062171 A2 discloses a process for removing acids which form as by-products in the course of a reaction or are added to a reaction mixture, for example for pH regulation, from the reaction mixtures by means of an auxiliary base such as 1-methylimidazole or 2-ethylpyridine. The acids form, with the auxiliary base, a liquid salt which is immiscible with the product of value and can therefore be removed by means of liquid-liquid phase separation. By way of example, silylations of alcohols or amines with halosilanes are described. Acids for removal which are disclosed are hydrochloric acid and acetic acid. A process for siloxylating monocarboxylic acids is not disclosed.

WO 2005/061416 A1 likewise discloses a process for removing acids from reaction mixtures by means of an auxiliary base, the auxiliary base being an alkylimidazole which has a solubility in 30% by weight sodium chloride solution at 25° C. of 10% by weight or less and whose hydrochloride has a melting point below 55° C. According to the teaching of this application, the auxiliary base is used to remove acids which form in the course of the reaction or are added during the reaction, for example for pH regulation. A process for siloxylating monocarboxylic acids is not disclosed.

WO 2010/072532 describes the silylation of monocarboxylic acids, but no siloxylation is disclosed.

The reaction of 1,5-dichlorohexamethyltrisiloxane with methacrylic acid in the presence of triethylamine as a base is described by Yoshida et al. in J. Jpn. Soc. Dent. Prod. 2000, 14(1), 8. The reaction products are also obtainable via the reaction of alkali metal methacrylates with α,ω-dichlorosiloxanes according to D. N. Andreev and N. T. Usacheva in Zhur. Obsh. Khim. 1965, 35(4), 756. In both reactions, the product has to be isolated by performing a complex solid-liquid separation which leads to product losses.

DE 10 2007 047866 A1 describes reactions of monocarboxylic esters with chlorosiloxanes, including the synthesis of nonamethyl tetrasiloxy methacrylate from trimethylsilyl methacrylate and chlorononamethyltetrasiloxane.

The preparation of chlorosiloxanes from chlorotrimethylsilane and hexamethylcyclotrisiloxane and octamethylcyclotetrasiloxane in the presence of a tetraalkylammonium salt is described in JP 2005/047852 A. The former reaction is already mentioned by T. Suzuki in Polymer, 1989, 30, 333. This reaction is also effected with N,N-dimethylformamide as a catalyst in moderate yields (UK 1040147)

EP 1 38 0611 A1, WO 2004/056838 A1 and WO 2004/00759 A1 describe the synthesis of nonamethyl tetrasiloxy methacrylate from trimethylsilyl methacrylate and hexamethylcyclotrisiloxane in the presence of an acidic catalyst, but this process affords only moderate yields.

It is therefore an object of the invention to provide a process for siloxylation of monocarboxylic acids, which features high yields and high selectivity and is economically attractive.

The object is achieved by a process for preparing a siloxy carboxylate, comprising the following steps:
a) reacting a C₂-C₁₀-monocarboxylic acid with a halosiloxane of the general formula (I),

Hal-(SiR₂—O)ₓ—SiR₃ (I)
in which
Hal is fluorine, chlorine, bromine or iodine,
R is the same or different and is hydrogen, C₁-C₁₀-alkyl or C₆-C₁₄-aryl and
x is an integer from 1 to 20,
in the presence of an auxiliary base and optionally of a solvent, the auxiliary base being selected such that it forms a salt with the hydrogen halide released in the reaction of monocarboxylic acid and halosiloxane, said salt being immiscible in the liquid phase with the siloxy carboxylate or the solution of the siloxy carboxylate in any solvent present, and any solvent used being selected such that it is miscible with the siloxy carboxylate and immiscible with the liquid salt of auxiliary base and hydrogen halide eliminated, and
b) separating the liquid phase which comprises the siloxy carboxylate and any solvent from the phase which comprises the salt of auxiliary base and the hydrogen halide eliminated at a temperature at which both phases are liquid.

In the process according to the invention, siloxy carboxylates are prepared in a simple and economically attractive manner, by virtue of the hydrogen halide released during the reaction and the auxiliary base forming a salt which is liquid under the reaction conditions and is immiscible with the siloxy carboxylate. The auxiliary base added surprisingly selectively removes the residual hydrogen halide and not the monocarboxylic acid from the reaction mixture. A simple liquid-liquid phase separation can separate the siloxy carboxylate from this salt of the auxiliary base with the hydrogen halide. The siloxylation of the monocarboxylic acid proceeds rapidly and with high yields.

The process according to the invention is suitable for the reaction of C₂-C₁₀-monocarboxylic acids with halosiloxanes of the general formula (I). It is unimportant whether the monocarboxylic acid is a straight-chain or branched and/or saturated or mono- or polyunsaturated monocarboxylic acid. The process according to the invention is preferentially suitable for saturated C₂-C₈-monocarboxylic acids and monoethylenically unsaturated C₃-C₈-monocarboxylic acids.

Saturated C₂-C₈-monocarboxylic acids are, for example, acetic acid, propionic acid, butyric acid, valeric acid (pentanoic acid), caproic acid (hexanoic acid), heptanoic acid and octanoic acid (caprylic acid), and isomers thereof. Preference is given to C₂-C₄-monocarboxylic acids such as acetic acid, propionic acid and butyric acid.

The group of the monoethylenically unsaturated monocarboxylic acids having 3 to 8 carbon atoms includes, for example, acrylic acid, methacrylic acid, dimethacrylic acid, ethacrylic acid, α-chloroacrylic acid, maleic acid, fumaric acid, itaconic acid, mesaconic acid, citraconic acid, glutaconic acid, aconitic acid, methylenemalonic acid, allylacetic acid, vinylacetic acid and crotonic acid. Preferred monoethylenically unsaturated monocarboxylic acids are acrylic acid, methacrylic acid, ethacrylic acid and maleic acid.

The C₂-C₁₀-monocarboxylic acid used is used, in relation to the halosiloxane, either in equimolar amounts or in excess. Preferably 1.0 to 2.0 mol/mol, more preferably 1.0 to 1.5 mol/mol and especially 1.0 to 1.25 mol/mol of monocarboxylic acid are used.

It will be appreciated that it is also possible in the process according to the invention to use any desired mixtures of the aforementioned C₂-C₁₀-monocarboxylic acids, but preference is given to reacting only one C₂-C₁₀-monocarboxylic acid with a halosiloxane.

The halosiloxanes are those of the general formula (I)

Hal-(SiR₂—O)ₓ—SiR₃ (I)

in which
Hal is fluorine, chlorine, bromine or iodine,
R is the same or different and is hydrogen, C₁-C₁₀-alkyl or aryl and
x is an integer from 1 to 20.

Hal is preferably chlorine or bromine. Preference is given to using one (1) halosiloxane, more preferably one (1) chloro- or bromosiloxane.

The R substituents may be the same or different and may each independently be hydrogen, C₁-C₁₀-alkyl or C₆-C₁₄-aryl. The R substituents are preferably the same or different and are each independently C₁-C₁₀-alkyl or C₆-C₁₄-aryl; they are more preferably the same and are each C₁-C₁₄-alkyl or phenyl.

In the context of the invention, C₁-C₁₀-alkyl is understood to mean straight-chain or branched hydrocarbon radicals having up to 10 carbon atoms, for example methyl, ethyl, propyl, isopropyl, n-butyl, sec-butyl, tert-butyl, 1,1-dimethylethyl, pentyl, 2-methylbutyl, 1,1-dimethylpropyl, 1,2-dimethylpropyl, 2,2-dimethylpropyl, 1-ethylpropyl, hexyl, 2-methylpentyl, 3-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 2-ethylbutyl, 1,1,2-trimethylpropyl, 1,2,2-trimethylpropyl, 1-ethyl-1-methylpropyl, 1-ethyl-2-methylpropyl, heptyl, octyl, 2-ethylhexyl, 2,4,4-trimethylpentyl, 1,1,3,3-tetramethylbutyl, nonyl and decyl, and isomers thereof. Preference is given to straight-chain or branched alkyl radicals having 1 to 4 carbon atoms.

Aryl is understood to mean mono- to tricyclic aromatic ring systems comprising 6 to 14 carbon ring members, for example phenyl, naphthyl and anthryl, preferably a monocyclic aromatic ring system, more preferably phenyl.

In the formula (I), x is an integer from 1 to 20, preferably an integer from 1 to 5 and more preferably 3 or 4.

Typically usable halosiloxanes are, for example, C₁—SiMe₂-O—SiMe₃, Cl—(SiMe₂—O)₂—SiMe₃, Cl—(SiMe₂—O)₃—SiMe₃, Cl—(SiMe₂—O)₄—SiMe₃, Cl—(SiMe₂—O)₅—SiMe₃, Br—(SiMe₂—O)₃—SiMe₃, Br—(SiMe₂-O)₄—SiMe₃, Cl—(SiEt₂-O)₃—SiMe₃, Cl—(SiEt₂-O)₄—SiMe₃, Cl—(SiMe₂—O)₃—SiEt₃, Cl—(SiMe₂-O)₄—SiEt₃, Cl—(SiMe₂—O)₃—SiPr₃, Cl—(SiMe₂—O)₄—SiPr₃, Cl—(SiMe₂—O)₃—SiPr₃, Cl—(SiMe₂—O)₄—SiPr₃, Cl—(SiMe₂—O)₃—SiBu₃ and Cl—(SiMe₂—O)₄—SiBu₃, preferably Cl—(SiMe₂-O)₃—SiMe₃ and Cl—(SiMe₂—O)₄—SiMe₃.

It will be appreciated that it is possible to use any desired mixtures of the halosiloxanes mentioned, but preference is given to using only one of the halosiloxanes mentioned.

Suitable auxiliary bases are especially those compounds specified in WO 03/062171 A2 and WO 05/061416 A1.

The compounds usable as auxiliary bases may comprise phosphorus, sulfur or nitrogen atoms, for example at least one nitrogen atom, preferably one to ten nitrogen atoms, more preferably one to five, even more preferably one to three and especially one to two nitrogen atoms. It is optionally also possible for further heteroatoms, such as oxygen, sulfur or phosphorus atoms, to be present.

Preference is given to those compounds which comprise at least one five- to six-membered heterocycle which has at least one nitrogen atom and optionally an oxygen or sulfur atom, particular preference to those compounds which comprise at least one five- to six-membered heterocycle which has one, two or three nitrogen atoms and a sulfur atom or an oxygen atom, very particular preference to those having two nitrogen atoms.

Particularly preferred compounds are those which have a molar mass less than 1000 g/mol, even more preferably less than 500 g/mol and especially less than 250 g/mol.

Additionally preferred are those compounds which are usable as bases and are selected from the compounds of the formulae (IIa) to (IIr)

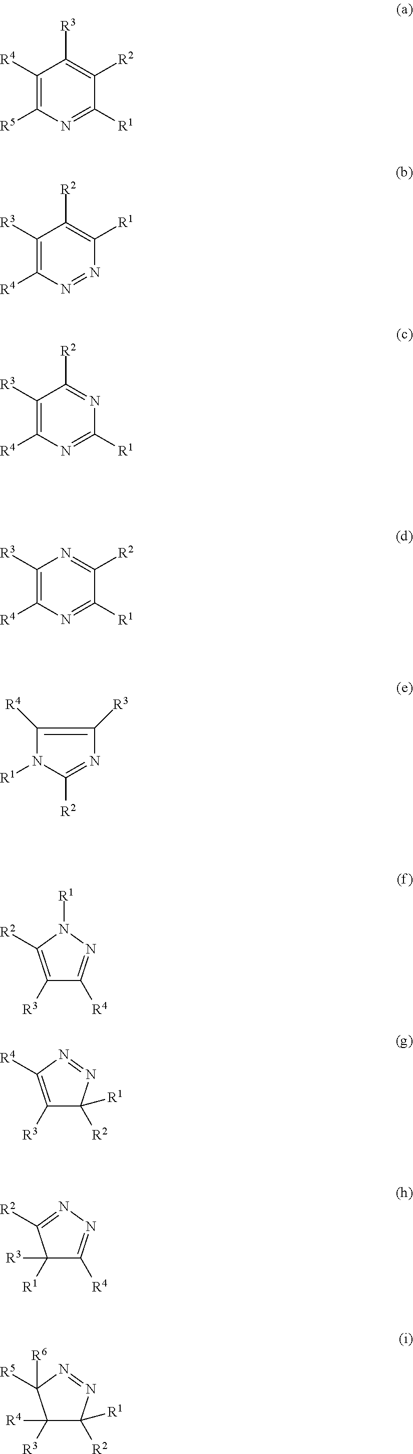

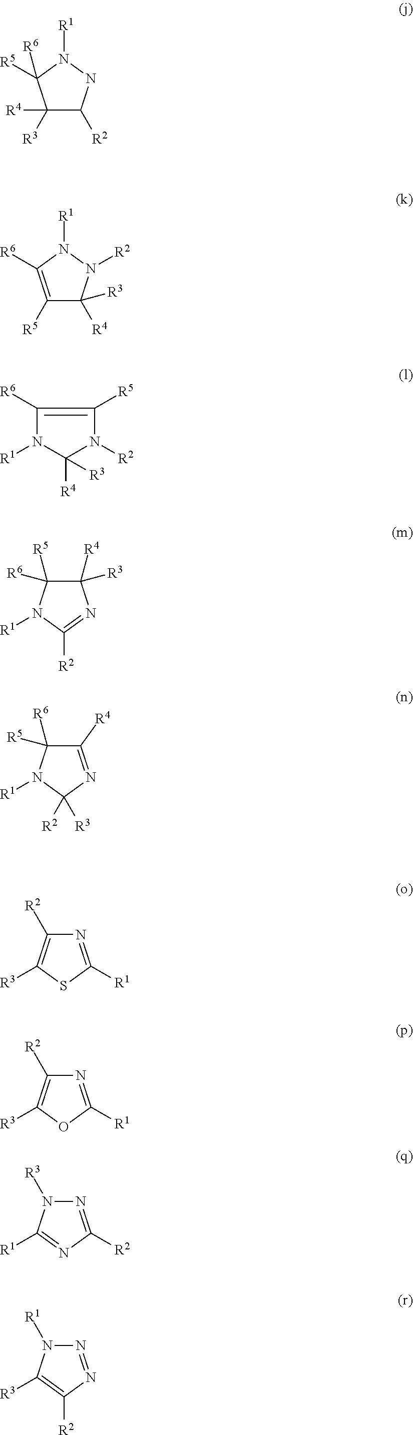

and oligo- or polymers which comprise these structures,
in which
R¹, R², R³, R⁴, R⁵ and R⁶ are each independently hydrogen, C₁-C₁₈-alkyl, C₂-C₁₈-alkyl which is optionally interrupted by one or more oxygen and/or sulfur atoms and/or one or more substituted or unsubstituted imino groups, C₆-C₁₂-aryl, C₅-C₁₂-cycloalkyl or a five- to six-membered heterocycle having oxygen, nitrogen and/or sulfur atoms, or two of them together form an unsaturated, saturated or aromatic ring optionally interrupted by one or more oxygen and/or sulfur atoms and/or one or more substituted or unsubstituted imino groups, where the radicals mentioned may each be substituted by functional groups, aryl, alkyl, aryloxy, alkyloxy, halogen, heteroatoms and/or heterocycles.

In these radicals,

C₁-C₁₈-alkyl optionally substituted by functional groups, aryl, alkyl, aryloxy, alkyloxy, halogen, heteroatoms and/or heterocycles is, for example, methyl, ethyl, propyl, isopropyl, n-butyl, sec-butyl, tert-butyl, pentyl, hexyl, heptyl, octyl, 2-ethylhexyl, 2,4,4-trimethylpentyl, decyl, dodecyl, tetradecyl, hexadecyl, octadecyl, 1,1-dimethylpropyl, 1,1-dimethylbutyl, 1,1,3,3-tetramethylbutyl, benzyl, 1-phenylethyl, 2-phenylethyl, α,α-dimethylbenzyl, benzhydryl, p-tolylmethyl, 1-(p-butylphenyl)ethyl, p-chlorobenzyl, 2,4-dichlorobenzyl, p-methoxybenzyl, m-ethoxybenzyl, 2-cyanoethyl, 2-cyanopropyl, 2-methoxycarbonylethyl, 2-ethoxycarbonylethyl, 2-butoxycarbonylpropyl, 1,2-di-(methoxycarbonyl)ethyl, 2-methoxyethyl, 2-ethoxyethyl, 2-butoxyethyl, diethoxymethyl, diethoxyethyl, 1,3-dioxolan-2-yl, 1,3-dioxan-2-yl, 2-methyl-1,3-dioxolan-2-yl, 4-methyl-1,3-dioxolan-2-yl, 2-isopropoxyethyl, 2-butoxypropyl, 2-octyloxyethyl, chloromethyl, 2-chloroethyl, trichloromethyl, trifluoromethyl, 1,1-dimethyl-2-chloroethyl, 2-methoxyisopropyl, 2-ethoxyethyl, butylthiomethyl, 2-dodecylthioethyl, 2-phenylthioethyl, 2,2,2-trifluoroethyl, 2-hydroxyethyl, 2-hydroxypropyl, 3-hydroxypropyl, 4-hydroxybutyl, 6-hydroxyhexyl, 2-aminoethyl, 2-aminopropyl, 3-aminopropyl, 4-aminobutyl, 6-aminohexyl, 2-methylaminoethyl, 2-methylaminopropyl, 3-methylaminopropyl, 4-methylaminobutyl, 6-methylaminohexyl, 2-dimethylaminoethyl, 2-dimethylaminopropyl, 3-dimethylaminopropyl, 4-dimethylaminobutyl, 6-dimethylaminohexyl, 2-hydroxy-2,2-dimethylethyl, 2-phenoxyethyl, 2-phenoxypropyl, 3-phenoxypropyl, 4-phenoxybutyl, 6-phenoxyhexyl, 2-methoxyethyl, 2-methoxypropyl, 3-methoxypropyl, 4-methoxybutyl, 6-methoxyhexyl, 2-ethoxyethyl, 2-ethoxypropyl, 3-ethoxypropyl, 4-ethoxybutyl or 6-ethoxyhexyl, and
C₂-C₁₈-alkyl optionally interrupted by one or more oxygen and/or sulfur atoms and/or one or more substituted or unsubstituted imino groups is, for example, 5-hydroxy-3-oxapentyl, 8-hydroxy-3,6-dioxaoctyl, 11-hydroxy-3,6,9-trioxaundecyl, 7-hydroxy-4-oxaheptyl, 11-hydroxy-4,8-dioxaundecyl, 15-hydroxy-4,8,12-trioxapentadecyl, 9-hydroxy-5-oxanonyl, 14-hydroxy-5,10-oxatetradecyl, 5-methoxy-3-oxapentyl, 8-methoxy-3,6-dioxaoctyl, 11-methoxy-3,6,9-trioxaundecyl, 7-methoxy-4-oxaheptyl, 11-methoxy-4,8-dioxaundecyl, 15-methoxy-4,8,12-trioxapentadecyl, 9-methoxy-5-oxanonyl, 14-methoxy-5,10-oxatetradecyl, 5-ethoxy-3-oxapentyl, 8-ethoxy-3,6-dioxaoctyl, 11-ethoxy-3,6,9-trioxaundecyl, 7-ethoxy-4-oxaheptyl, 11-ethoxy-4,8-dioxaundecyl, 15-ethoxy-4,8,12-trioxapentadecyl, 9-ethoxy-5-oxanonyl or 14-ethoxy-5,10-oxatetradecyl.

When two radicals form a ring, these radicals together may be 1,3-propylene, 1,4-butylene, 2-oxa-1,3-propylene, 1-oxa-1,3-propylene, 2-oxa-1,3-propylene, 1-oxa-1,3-propenylene, 1-aza-1,3-propenylene, 1-C₁-C₄-alkyl-1-aza-1,3-propenylene, 1,4-buta-1,3-dienylene, 1-aza-1,4-buta-1,3-dienylene or 2-aza-1,4-buta-1,3-dienylene.

The number of oxygen and/or sulfur atoms and/or imino groups is unlimited. In general, it is not more than 5 in the radical, preferably not more than 4 and most preferably not more than 3.

In addition, there is generally at least one carbon atom, preferably at least two, between two heteroatoms.

Substituted and unsubstituted imino groups may, for example, be imino, methylimino, isopropylimino, n-butylimino or tert-butylimino.

In addition,

functional groups are carboxyl, carboxamide, hydroxyl, di-(C₁-C₄-alkyl)amino, C₁-C₄-alkyloxycarbonyl, cyano or C₁-C₄-alkyloxy,
C₆-C₁₂-aryl optionally substituted by functional groups, aryl, alkyl, aryloxy, alkyloxy, halogen, heteroatoms and/or heterocycles is, for example, phenyl, tolyl, xylyl, α-naphthyl, β-naphthyl, 4-diphenylyl, chlorophenyl, dichlorophenyl, trichlorophenyl, difluorophenyl, methylphenyl, dimethylphenyl, trimethylphenyl, ethylphenyl, diethylphenyl, isopropylphenyl, tert-butylphenyl, dodecylphenyl, methoxyphenyl, dimethoxyphenyl, ethoxyphenyl, hexyloxyphenyl, methylnaphthyl, isopropylnaphthyl, chloronaphthyl, ethoxynaphthyl, 2,6-dimethylphenyl, 2,4,6-trimethylphenyl, 2,6-dimethoxyphenyl, 2,6-dichlorophenyl, 4-bromophenyl, 2- or 4-nitrophenyl, 2,4- or 2,6-dinitrophenyl, 4-dimethylaminophenyl, 4-acetylphenyl, methoxyethylphenyl or ethoxymethylphenyl,
C₅-C₁₂-cycloalkyl optionally substituted by functional groups, aryl, alkyl, aryloxy, alkyloxy, halogen, heteroatoms and/or heterocycles is, for example, cyclopentyl, cyclohexyl, cyclooctyl, cyclododecyl, methylcyclopentyl, dimethylcyclopentyl, methylcyclohexyl, dimethylcyclohexyl, diethylcyclohexyl, butylcyclohexyl, methoxycyclohexyl, dimethoxycyclohexyl, diethoxycyclohexyl, butylthiocyclohexyl, chlorocyclohexyl, dichlorocyclohexyl, dichlorocyclopentyl, and a saturated or unsaturated bicyclic system, such as norbornyl or norbornenyl,
a five- to six-membered heterocycle having oxygen, nitrogen and/or sulfur atoms is, for example, furyl, thiophenyl, pyrryl, pyridyl, indolyl, benzoxazolyl, dioxolyl, dioxyl, benzimidazolyl, benzthiazolyl, dimethylpyridyl, methylquinolyl, dimethylpyrryl, methoxyfuryl, dimethoxypyridyl, difluoropyridyl, methylthiophenyl, isopropylthiophenyl or tert-butylthiophenyl, and
C₁ to C₄₋alkyl is methyl, ethyl, propyl, isopropyl, n-butyl, sec-butyl or tert-butyl.

Preferably, R¹, R², R³, R⁴, R⁵ and R⁶ are each independently hydrogen, methyl, ethyl, n-butyl, 2-hydroxyethyl, 2-cyanoethyl, 2-(methoxycarbonyl)ethyl, 2-(ethoxycarbonyl)ethyl, 2-(n-butoxycarbonyl)ethyl, dimethylamino, diethylamino and chlorine.

Particularly preferred pyridines (IIa) are those in which one of the R¹ to R⁵ radicals is methyl, ethyl or chlorine and all others are hydrogen, or R³ is dimethylamino and all others are hydrogen, or all are hydrogen, or R² is carboxyl or carboxamide and all others are hydrogen, or R¹ and R² or R² and R³ are 1,4-buta-1,3-dienylene and all others are hydrogen.

Particularly preferred pyridazines (IIb) are those in which one of the R¹ to R⁴ radicals is methyl or ethyl and all others are hydrogen, or all are hydrogen.

Particularly preferred pyrimidines (IIc) are those in which R² to R⁴ are each hydrogen or methyl and R¹ is hydrogen, methyl or ethyl, or R² and R⁴ are each methyl, R³ is hydrogen and R¹ is hydrogen, methyl or ethyl.

Particularly preferred pyrazines (IId) are those in which R¹ to R⁴ are all methyl or all hydrogen.

Particularly preferred imidazoles (IIe) are those in which

R¹ is each independently selected from methyl, ethyl, n-propyl, n-butyl, n-pentyl, n-octyl, 2-hydroxyethyl and 2-cyanoethyl, and
R² to R⁴ are each independently hydrogen, methyl or ethyl.

Particularly preferred 1 H-pyrazoles (IIf) are those in which, each independently,

R¹ is selected from hydrogen, methyl and ethyl,
R², R³ and R⁴ from hydrogen and methyl.

Particularly preferred 3H-pyrazoles (Hg) are those in which, each independently,

R¹ is selected from hydrogen, methyl and ethyl,
R², R³ and R⁴ from hydrogen and methyl.

Particularly preferred 4H-pyrazoles (IIh) are those in which, each independently,

R¹ to R⁴ are selected from hydrogen and methyl.

Particularly preferred 1-pyrazolines (IIi) are those in which, each independently,

R¹ to R⁶ are selected from hydrogen and methyl.

Particularly preferred 2-pyrazolines (IIj) are those in which, each independently,

R¹ is selected from hydrogen, methyl, ethyl and phenyl, and
R² to R⁶ from hydrogen and methyl.

Particularly preferred 3-pyrazolines (IIk) are those in which, each independently,

R¹ or R² is selected from hydrogen, methyl, ethyl and phenyl, and
R³ to R⁶ from hydrogen and methyl.

Particularly preferred imidazolines (III) are those in which, each independently,

R¹ or R² is selected from hydrogen, methyl, ethyl, n-butyl and phenyl, and
R³ or R⁴ from hydrogen, methyl and ethyl, and
R⁵ or R⁶ from hydrogen and methyl.

Particularly preferred imidazolines (IIm) are those in which, each independently,

R¹ or R² is selected from hydrogen, methyl and ethyl, and
R³ to R⁶ from hydrogen and methyl.

Particularly preferred imidazolines (IIn) are those in which, each independently,

R¹, R² or R³ is selected from hydrogen, methyl and ethyl, and
R⁴ to R⁶ from hydrogen and methyl.

Particularly preferred thiazoles (IIo) or oxazoles (IIp) are those in which, each independently,

R¹ is selected from hydrogen, methyl, ethyl and phenyl, and
R² or R³ from hydrogen and methyl.

Particularly preferred 1,2,4-triazoles (IIq) are those in which, each independently,

R¹ or R² is selected from hydrogen, methyl, ethyl and phenyl, and
R³ from hydrogen, methyl and phenyl.

Particularly preferred 1,2,3-triazoles (IIr) are those in which, each independently,

R¹ is selected from hydrogen, methyl and ethyl and
R² or R³ from hydrogen and methyl, or
R² and R³ are 1,4-buta-1,3-dienylene and all others are hydrogen.

Among these, the pyridines and the imidazoles are preferred.

Very particularly preferred bases are 3-chloropyridine, 4-dimethylaminopyridine, 2-ethyl-4-aminopyridine, 2-methylpyridine (α-picoline), 3-methylpyridine (β-picoline), 4-methylpyridine (γ-picoline), 2-ethylpyridine, 2-ethyl-6-methylpyridine, quinoline, isoquinoline, 1-C₁-C₄-alkylimidazole, 1-methylimidazole, 1,2-dimethylimidazole, 1-n-butylimidazole, 1,4,5-trimethylimidazole, 1,4-dimethylimidazole, imidazole, 2-methylimidazole, 1-butyl-2-methylimidazole, 4-methylimidazole, 1-n-pentylimidazole, 1-n-hexylimidazole, 1-n-octylimidazole, 1-(2′-aminoethyl)imidazole, 2-ethyl-4-methylimidazole, 1-vinylimidazole, 2-ethylimidazole, 1-(2′-cyanoethyl)imidazole and benzotriazole.

Especially preferred are 1-n-butylimidazole, 1-methylimidazole, 2-methylpyridine and 2-ethylpyridine.

Additionally suitable are tertiary amines of the formula (III)

NR^{a}R^{b}R^{c} (III)

in which
R^{a}, R^{b} and R^{c} are each independently C₁-C₁₈-alkyl, C₂-C₁₈-alkyl which is optionally interrupted by one or more oxygen and/or sulfur atoms and/or one or more substituted or unsubstituted imino groups, C₆-C₁₂-aryl, C₅-C₁₂-cycloalkyl or a five- to six-membered heterocycle having oxygen, nitrogen and/or sulfur atoms, or two of them together form an unsaturated, saturated or aromatic ring optionally interrupted by one or more oxygen and/or sulfur atoms and/or one or more substituted or unsubstituted imino groups, where the radicals mentioned may each be substituted by functional groups, aryl, alkyl, aryloxy, alkyloxy, halogen, heteroatoms and/or heterocycles,
with the proviso that
at least two of the three R^{a}, R^{b} and R^{c} radicals are different and
the R^{a}, R^{b} and R^{c} radicals together have at least 8, preferably at least 10, more preferably at least 12 and most preferably at least 13 carbon atoms.

R^{a}, R^{b} and R^{c} are preferably each independently C₁-C₁₈-alkyl, C₅-C₁₂-aryl or C₅-C₁₂-cycloalkyl, and more preferably C₁-C₁₈-alkyl, where the radicals mentioned may each be substituted by functional groups, aryl, alkyl, aryloxy, alkyloxy, halogen, heteroatoms and/or heterocycles.

Examples of the particular groups have already been listed above.

Preferred definitions of the R^{a}, R^{b} and R^{c} radicals are methyl, ethyl, n-propyl, isopropyl, n-butyl, sec-butyl, tert-butyl, n-pentyl (n-amyl), 2-pentyl (sec-amyl), 3-pentyl, 2,2-dimethylprop-1-yl (neopentyl), n-hexyl, n-heptyl, n-octyl, isooctyl, 2-ethylhexyl, 1,1-dimethylpropyl, 1,1-dimethylbutyl, benzyl, 1-phenylethyl, 2-phenylethyl, α,α-dimethylbenzyl, phenyl, tolyl, xylyl, α-naphthyl, β-naphthyl, cyclopentyl or cyclohexyl.

When two of the R^{a}, R^{b} and R^{c} radicals form a chain, this may, for example, be 1,4-butylene or 1,5-pentylene.

Examples of the tertiary amines of the formula (III) are diethyl-n-butylamine, diethyl-tert-butylamine, diethyl-n-pentylamine, diethylhexylamine, diethyloctylamine, diethyl-(2-ethylhexyl)amine, di-n-propylbutylamine, di-n-propyl-n-pentylamine, di-n-propylhexylamine, di-n-propyloctylamine, di-n-propyl-(2-ethylhexyl)amine, diisopropylethylamine, diisopropyl-n-propylamine, diisopropylbutylamine, diisopropylpentylamine, diisopropylhexylamine, diisopropyloctylamine, diisopropyl-(2-ethylhexyl)amine, di-n-butylethylamine, din-butyl-n-propylamine, di-n-butyl-n-pentylamine, di-n-butylhexylamine, di-n-butyloctylamine, di-n-butyl-(2-ethylhexyl)amine, N-n-butylpyrrolidine, N-sec-butylpyrrolidine, N-tert-butylpyrrolidine, N-n-pentylpyrrolidine, N,N-dimethylcyclohexylamine, N,N-diethylcyclohexylamine, N,N-di-n-butylcyclohexylamine, N-n-propylpiperidine, N-isopropylpiperidine, N-n-butylpiperidine, N-sec-butylpiperidine, N-tert-butylpiperidine, N-n-pentylpiperidine, N-n-butylmorpholine, N-sec-butylmorpholine, N-tert-butylmorpholine, N-n-pentylmorpholine, N-benzyl-N-ethylaniline, N-benzyl-N-n-propylaniline, N-benzyl-N-isopropylaniline, N-benzyl-N-n-butylaniline, N,N-dimethyl-p-toluidine, N,N-diethyl-p-toluidine, N,N-di-n-butyl-p-toluidine, diethylbenzylamine, di-n-propylbenzylamine, di-n-butylbenzylamine, diethylphenylamine, di-n-propylphenylamine and di-n-butylphenylamine.

Preferred tertiary amines (III) are diisopropylethylamine, diethyl-tert-butylamine, diisopropylbutylamine, di-n-butyl-n-pentylamine, N,N-di-n-butylcyclohexylamine, and tertiary amines of pentyl isomers.

Particularly preferred tertiary amines are di-n-butyl-n-pentylamine and tertiary amines of pentyl isomers.

A tertiary amine which is likewise preferred and can be used in accordance with the invention, but in contrast to the above-listed amines has three identical radicals, is triallylamine.

Tertiary amines, preferably of the formula (III), are generally preferred over heterocyclic compounds, for example of the formulae (IIIa) to (IIIr), when the basicity of the latter auxiliary bases is insufficient for the reaction, for example for eliminations.

Preference is given to those auxiliary bases whose salts of auxiliary bases and acids have a melting temperature at which, in the course of the removal of the salt as a liquid phase, no significant decomposition of the siloxy carboxylate occurs, i.e. less than 10 mol % per hour, preferably less than 5 mol %/h, more preferably less than 2 mol %/h and most preferably less than 1 mol %/h.

The melting points of the salts of the particularly preferred auxiliary bases are generally below 160° C., more preferably below 100° C. and most preferably below 80° C.

Among the auxiliary bases, very particular preference is given to those bases whose salts have an E_{T}(30) of >35, preferably of >40, more preferably of >42. The E_{T}(30) is a measure of the polarity and is described by C. Reichardt in Reichardt, Christian, Solvent Effects in Organic Chemistry Weinheim: VCH, 1979-XI, (Monographs in Modern Chemistry; 3), ISBN 3-527-25793-4 page 241.

A preferred base which, for example, fulfills the objective is 1-methylimidazole.

1-Methylimidazole is additionally effective as a nucleophilic catalyst [Julian Chojnowski, Marek Cypryk, Witold Fortuniak, Heteroatom. Chemistry, 1991, 2, 63-70]. Chojnowski et al. found that 1-methylimidazole in comparison with triethylamine accelerates the phosphorylation of t-butanol by a factor of 33 and the silylation of pentamethyldisiloxanol by a factor of 930.

Instead of 1-methylimidazole, 1-butylimidazole, for example, can also be used. The hydrochloride of 1-butylimidazole is already liquid at room temperature, so that 1-butylimidazole may be used as an auxiliary base and catalyst for reactions in which materials are handled which are liable to decompose even above room temperature. The acetate and formate of 1-methylimidazole are likewise liquid at room temperature.

It is equally possible to use all derivatives of imidazole whose salts have an E_{T}(30) of >35, preferably of >40, more preferably of >42 and a melting point at which in the course of removal of the salt as a liquid phase no significant decomposition of the siloxy carboxylate occurs. The polar salts of these imidazoles form two immiscible phases with less polar organic media as described above.

A further highly preferred base which achieves the object is 2-ethylpyridine.

Pyridine itself and derivatives of pyridine are known to those skilled in the art as nucleophilic catalysts [Jerry March, “Advanced Organic Chemistry”, 3rd edition, John Wiley & Sons, New York 1985, p. 294, 334, 347].

It has also been found that the hydrochloride of 2-ethylpyridine has a melting point of about 55° C. and is immiscible with nonpolar organic siloxy carboxylates or solvents. 2-Ethylpyridine can also serve at the same time as an auxiliary base and nucleophilic catalyst and is separated from organic media as a liquid hydrochloride by a liquid-liquid phase separation which is simple from a process engineering point of view.

It is equally possible to use all derivatives of pyridine whose salts have an E_{T}(30) of >35, preferably of >40, more preferably of >42 and a melting point at which in the course of removal of the salt as a liquid phase no significant decomposition of the product of value occurs. The polar salts of these pyridines form two immiscible phases with less polar organic media.

Preferred auxiliary bases are also alkylimidazoles of the formula (IV),

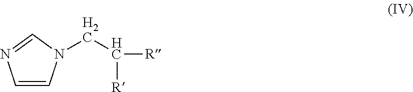

in which R′ and R″ may each independently be hydrogen or linear or branched C₁-C₆-alkyl, with the condition that R′ and R″ have a total of at least 1 carbon atom and a total of not more than 6 carbon atoms, preferably a total of 1 to 4 carbon atoms, more preferably a total of 1 to 2 carbon atoms and most preferably a total of 2 carbon atoms.

Examples of R′ and R″ are hydrogen, methyl, ethyl, iso-propyl, n-propyl, n-butyl, iso-butyl, sec-butyl, tert-butyl and n-hexyl. Preferred R′ and R″ radicals are hydrogen, methyl and ethyl.

Examples of compounds of the formula (IV) are n-propylimidazole, n-butylimidazole, iso-butylimidazole, 2′-methylbutylimidazole, iso-pentylimidazole, n-pentylimidazole, iso-hexylimidazole, n-hexylimidazole, iso-octylimidazole and n-octylimidazole.

Preferred compounds (IV) are n-propylimidazole, n-butylimidazole and iso-butylimidazole, particular preference being given to n-butylimidazole and iso-butylimidazole, and very particular preference to n-butylimidazole.

According to the invention, auxiliary bases are those compounds which form a salt with the hydrogen halide formed during the reaction, said salt forming two immiscible phases with the siloxy carboxylate or the solution of the siloxy carboxylate in a suitable solvent at the reaction temperature, and being removed.

Preference is given to those auxiliary bases which are not involved in the reaction as a reactant. Additionally preferably, this auxiliary base may function as a nucleophilic catalyst in the reaction, such that the addition of a further base, for example the diethylamine or triethylamine bases cited in the literature, is not required.

As described above, the auxiliary base and the hydrogen halide formed during the reaction form a salt. According to the halosiloxane used, this is hydrogen fluoride (HF), hydrogen chloride (HCl), hydrogen bromide (HBr) or hydrogen iodide (HI), or, in the case of mixed halosiloxanes of the formula (I), mixtures of the hydrogen halides mentioned. In the process according to the invention, hydrogen chloride (HCl) or hydrogen bromide (HBr) is formed preferentially.

The auxiliary base is additionally suitable for binding other acids which are added, for example, during the reaction for pH regulation, for example nitric acid, nitrous acid, carbonic acid, sulfuric acid, phosphoric acid or sulfonic acids such as methanesulfonic acid, ethanesulfonic acid, benzenesulfonic acid or p-toluenesulfonic acid.

When the reaction mixture does not comprise any further acids in addition to the C₂-C₁₀-monocarboxylic acid used, generally at least one mole of auxiliary base is used per mole of hydrogen halide to be removed, preferably 1.0 to 1.5 mol/mol, more preferably 1.0 to 1.3 mol/mol and especially 1.0 to 1.25 mol/mol. When other acids have been added, for example for pH regulation, the amount of auxiliary base has to be adjusted correspondingly.

In general, the residence time of the auxiliary base in the reaction mixture is a few minutes to several hours, preferably 5 to 120 minutes, more preferably 10 to 60 minutes and most preferably 10 to 30 minutes.

Typically, the auxiliary base is initially charged together with the C₂-C₁₀-monocarboxylic acid to be siloxylated and then the halosiloxane is added fully or continuously.

The salt of the auxiliary base with the hydrogen halide formed during the reaction forms two immiscible phases with the siloxy carboxylate or a solution of the siloxy carboxylate in a suitable solvent. “Immiscible” means that two liquid phases separated by a phase interface form.

When the pure siloxy carboxylate is miscible entirely or to a relatively high degree with the salt of the auxiliary base and the hydrogen halide, a solvent can also be added to the siloxy carboxylate, in order to achieve demixing or a reduction in solubility. This is advisable, for example, when the solubility of the salt in the siloxy carboxylate or vice versa is 20% by weight or more, preferably 15% by weight or more, more preferably 10% by weight or more and most preferably 5% by weight or more. The solubility is determined under the conditions of the particular separation. The solubility is preferably determined at a temperature which is above the melting point of the salt and preferably 10° C., more preferably 20° C., below the lowest of the following temperatures: boiling point of the siloxy carboxylate, boiling point of the solvent and temperature of significant decomposition of the siloxy carboxylate.

The solvent is suitable when the mixture of siloxy carboxylate and solvent is capable of dissolving the salt or the salt is capable of dissolving the siloxy carboxylate or a mixture of siloxy carboxylate and solvent to a lesser degree than the amounts specified above. Examples of suitable solvents include benzene, toluene, o-, m- or p-xylene, cyclohexane, cyclopentane, pentane, hexane, heptane, octane, petroleum ether, acetone, isobutyl methyl ketone, diethyl ketone, diethyl ether, tert-butyl methyl ether, tert-butyl ethyl ether, tetrahydrofuran, dioxane, ethyl acetate, methyl acetate, dimethylformamide, dimethyl sulfoxide, acetonitrile, chloroform, dichloromethane, methylchloroform or mixtures thereof.

In general, the siloxy carboxylate is, however, immiscible with the salt of auxiliary base and hydrogen halide, and so the addition of a solvent can be dispensed with.

The particular advantage of the process according to the invention is that the salt of auxiliary base and hydrogen halide can be removed by a simple liquid-liquid phase separation, and so there is no need to handle solids, which is complicated in terms of process technology.

The person skilled in the art can recover the free auxiliary base in a known manner from the salt of the auxiliary base removed from the siloxy carboxylate, and feed it back to the process.

The free auxiliary base can be recovered, for example, by releasing the salt of the auxiliary base with a strong base, for example NaOH, KOH, Ca(OH)₂, milk of lime, Na₂CO₃, NaHCO₃, K₂CO₃ or KHCO₃, optionally in a solvent, such as water, methanol, ethanol, n- or isopropanol, n-butanol, n-pentanol, butanol or pentanol isomer mixtures or acetone. The auxiliary base thus released can, if it forms a separate phase, be removed, or, if it is miscible with the salt of the stronger base or the solution of the salt of the stronger base, be removed by distillation out of the mixture. If required, the auxiliary base released can also be removed from the salt of the stronger base or the solution of the salt of the stronger base by extraction with an extractant, such as solvents, alcohols or amines.

If required, the auxiliary base can be washed with water or aqueous NaCl or Na₂SO₄ solution and then dried, for example by removing any water present with the aid of an azeotropic distillation with benzene, toluene, xylene, butanol or cyclohexane.

If required, the auxiliary base can be distilled before reuse in the process according to the invention.

As described above, the auxiliary base is suitable firstly for removing the hydrogen halide formed during the reaction and secondly as a nucleophilic catalyst in the siloxylation of the C₂-C₁₀-monocarboxylic acid.

The performance of the siloxylation is not restricted and can, in accordance with the invention, be performed with scavenging of the hydrogen halide released and of any acid added, batchwise or continuously, and under air or under a protective gas atmosphere.

The siloxylation can be performed at ambient pressure, or else under elevated pressure or reduced pressure, preference being given to working under standard pressure.

The reaction temperature is selected such that the salt of the auxiliary base with the hydrogen halide is present in liquid form at the particular pressure, such that a liquid-liquid phase separation is possible.

Monoethylenically unsaturated C₃-C₈-monocarboxylic acids and siloxylation products thereof are polymerizable compounds. It is therefore important in the case of siloxylation of monoethylenically unsaturated C₃-C₈-monocarboxylic acids to ensure sufficient inhibition of polymerization and therefore to work in the presence of customary amounts of polymerization inhibitors known per se. Undesired polymerization is a safety hazard owing to the large amount of heat released.

In general, based on the monoethylenically unsaturated monocarboxylic acid, according to the individual substance, from 1 to 10 000 ppm, preferably from 10 to 5000 ppm, more preferably from 30 to 2500 ppm and especially from 50 to 1500 ppm of a suitable stabilizer is used.

Suitable stabilizers are, for example, N-oxides (nitroxyl or N-oxyl radicals, i.e. compounds which have at least one >N—O group), such as 4-hydroxy-2,2,6,6-tetramethylpiperidine N-oxyl, 4-oxo-2,2,6,6-tetramethylpiperidine N-oxyl, 4-acetoxy-2,2,6,6-tetramethylpiperidine N-oxyl, 2,2,6,6-tetramethylpiperidine N-oxyl, 4,4′,4″-tris(2,2,6,6-tetramethylpiperidine N-oxyl) phosphite or 3-oxo-2,2,5,5-tetramethyl-pyrrolidine N-oxyl; mono- or polyhydric phenols which may have one or more alkyl groups, such as alkylphenols, for example o-, m- or p-cresol (methylphenol), 2-tert-butylphenol, 4-tert-butylphenol, 2,4-di-tert-butylphenol, 2-methyl-4-tert-butylphenol, 2-tert-butyl-4-methylphenol, 2,6-tert-butyl-4-methylphenol, 4-tert-butyl-2,6-dimethylphenol or 6-tert-butyl-2,4-dimethylphenol; quinones, such as hydroquinone, hydroquinone monomethyl ether, 2-methylhydroquinone or 2,5-di-tert-butylhydroquinone; hydroxyphenols, for example pyrocatechol (1,2-dihydroxybenzene) or benzoquinone; aminophenols, such as p-aminophenol; nitrosophenols, such as p-nitrosophenol; alkoxyphenols, for example 2-methoxyphenol (guaiacol, pyrocatechol monomethyl ether), 2-ethoxyphenol, 2-isopropoxyphenol, 4-methoxyphenol (hydroquinone monomethyl ether), mono- or di-tert-butyl-4-methoxyphenol; tocopherols, such as a-tocopherol and 2,3-dihydro-2,2-dimethyl-7-hydroxybenzofuran (2,2-dimethyl-7-hydroxycoumaran), aromatic amines, such as N,N-diphenylamine or N-nitrosodiphenylamine; phenylenediamines, such as N,N′-dialkyl-p-phenylenediamine, where the alkyl radicals may be the same or different and each consist independently of from 1 to 4 carbon atoms and may be straight-chain or branched, such as N,N′-dimethyl-p-phenylenediamine or N,N′-diethyl-p-phenylenediamine, hydroxylamines, such as N,N-diethylhydroxylamine, imines, such as methyl ethyl imine or methylene violet, sulfonamides, for example N-methyl-4-toluenesulfonamide or N-tert-butyl-4-toluenesulfonamide, oximes, such as aldoximes, ketoximes or amide oximes, such as diethyl ketoxime, methyl ethyl ketoxime or salicylaldoxime, phosphorus compounds, such as triphenylphosphine, triphenyl phosphite, triethyl phosphite, hypophosphorous acid or alkyl esters of phosphorous acids; sulfur compounds, such as diphenyl sulfide or phenothiazine; metal salts such as copper or manganese, cerium, nickel, chromium salts, for example chlorides, sulfates, salicylates, tosylates, acrylates or acetates, such as copper acetate, copper(II) chloride, copper salicylate, cerium(III) acetate or cerium(III) ethylhexanoate, or mixtures thereof.

The polymerization inhibitor (mixture) used is preferably at least one compound from the group of hydroquinone, hydroquinone monomethyl ether, phenothiazine, 4-hydroxy-2,2,6,6-tetramethylpiperidine N-oxyl, 4-oxo-2,2,6,6-tetramethylpiperidine N-oxyl, 2-tert-butylphenol, 4-tert-butylphenol, 2,4-di-tert-butylphenol, 2-tert-butyl-4-methylphenol, 6-tert-butyl-2,4-dimethylphenol, 2,6-di-tert-butyl-4-methylphenol, 2-methyl-4-tert-butylphenol, hypophosphorous acid, copper acetate, copper(II) chloride, copper salicylate and cerium(III) acetate.

Very particular preference is given to using phenothiazine and/or hydroquinone monomethyl ether (MEHQ) as the polymerization inhibitor.

To further support the stabilization, an oxygenous gas may be present, preferably air or a mixture of air and nitrogen (lean air).

The siloxylation reactants and any other assistants present, such as solvents or polymerization inhibitors, can be added as desired.

In a preferred embodiment, the C₂-C₁₀-monocarboxylic acid and the auxiliary base are each initially charged at least partly, preferably each fully, in a suitable reactor and heated. Subsequently, the halosiloxane is metered in, the metered addition generally being effected within a few minutes to several hours, preferably 5 to 120 minutes, more preferably 10 to 60 minutes and most preferably 10 to 30 minutes, continuously or in portions.

The siloxylation is followed, as described, by the liquid-liquid removal of the salt of the auxiliary base and the subsequent recovery of the auxiliary base from the phase removed.

The siloxylated C₂-C₁₀-monocarboxylic acids prepared by the process according to the invention can be used as comonomers in copolymers for a wide variety of different applications, for example for hydrophobization of coating materials or for the production of antifouling paints.

The examples which follow are intended to illustrate the invention, but without restricting it.

Percentage and ppm data used in this document are based, unless stated otherwise, on percentages and ppm by weight.

### EXAMPLES

### Example 1

### Preparation of Nonamethyl Tetrasiloxy Methacrylate (MAD3M)

A 2 l jacketed flange reactor was initially charged with 162 g (1.88 mol; 1.13 equivalents) of methacrylic acid and 136 g (1.66 mol) of 1-methylimidazole under argon. Subsequently, 546 g (purity: 97%; 1.65 mol) of 1-chlorononamethyltetrasiloxane were added within one minute, in the course of which the internal temperature rose to 70° C. Thereafter, the jacket temperature was increased to 90° C. and the reaction mixture was stirred for a further one hour. Then the two phases were separated within two hours to obtain 211 g of 1-methylimidazolium chloride lower phase and 624 g of upper phase. According to GC analysis, the upper phase consisted to an extent of 95% of nonamethyl tetrasiloxy methacrylate (MAD3M, 1.56 mol), and this corresponds to a yield of 95%.

### Example 2

### Preparation of Undecamethyl Pentasiloxy Methacrylate (MAD4M)

A 500 ml four-neck flask was initially charged with 29.3 g (0.34 mol; 1.3 equivalents) of methacrylic acid and 23.3 g (0.28 mol; 1.1 equivalents) of 1-methylimidazole under argon. Subsequently, 114 g (purity: 94%; 0.26 mol) of 1-chloroundecamethylpentasiloxane were added within one minute, in the course of which the internal temperature rose to 65° C. Thereafter, the flask was heated to 90° C. in an oil bath for two hours, then the two phases were separated within two hours to obtain 39 g of 1-methylimidazolium chloride lower phase and 127 g of upper phase. According to GC analysis, the upper phase consisted to an extent of 91% of undecamethyl pentasiloxy methacrylate (MAD4M; 0.25 mol), and this corresponds to a yield of 96%.

### Example 3

### Preparation of Nonamethyl Tetrasiloxy Acrylate (AD3M)

A 2 l jacketed flange reactor was initially charged with 131 g (1.81 mol; 1.3 equivalents) of acrylic acid and 124 g (1.51 mol; 1.1 equivalents) of 1-methylimidazole under argon. Subsequently, 500 g (purity: 95%; 1.43 mol) of 1-chlorononamethyltetrasiloxane were added within one minute, in the course of which the internal temperature rose to 70° C. Thereafter, the jacket temperature was increased to 90° C. and the reaction mixture was stirred for a further one hour. Then the two phases were separated within two hours to obtain 200 g of 1-methylimidazolium chloride lower phase and 547 g of upper phase. According to GC analysis, the upper phase consisted to an extent of 90% of nonamethyl tetrasiloxy acrylate (AD3M; 1.34 mol), and this corresponds to a yield of 94%.

1. A process for preparing a siloxy carboxylate, comprising the following steps:
a) reacting a C₂-C₁₀-monocarboxylic acid with a halosiloxane of the general formula (I),
Hal-(SiR₂-0)ₙ—SiR₃ (I)
in which
Hal is fluorine, chlorine, bromine or iodine,
R is the same or different and is hydrogen, C₁-C₁₀-alkyl or C₆-C₁₄-aryl and
x is an integer from 1 to 20,
in the presence of an auxiliary base and optionally of a solvent, the auxiliary base being selected such that it forms a salt with the hydrogen halide released in the reaction of monocarboxylic acid and halosiloxane, said salt being immiscible in the liquid phase with the siloxy carboxylate or the solution of the siloxy carboxylate in any solvent present, and any solvent used being selected such that it is miscible with the siloxy carboxylate and immiscible with the liquid salt of auxiliary base and hydrogen halide eliminated, and
b) separating the liquid phase which comprises the siloxy carboxylate and any solvent from the phase which comprises the salt of auxiliary base and the hydrogen halide eliminated at a temperature at which both phases are liquid.

2. The process according to claim 1, wherein the C₂-C₁₀-monocarboxylic acid is a saturated C₂-C₈-monocarboxylic acid or a monoethylenically unsaturated C₃-C₈-monocarboxylic acid.

3. The process according to claim 2, wherein the saturated C₂-C₈-monocarboxylic acid is acetic acid, propionic acid or butyric acid.

4. The process according to claim 2, wherein the monoethylenically unsaturated C₂-C₈-monocarboxylic acid is acrylic acid, methacrylic acid, ethacrylic acid or maleic acid.

5. The process according to claim 1, wherein Hal is chlorine or bromine.

6. The process according to claim 1, wherein the R substituents of the halosiloxane are the same and are each C₁-C₄-alkyl or phenyl.

7. The process according to claim 1, wherein the halosiloxane is Cl—(SiMe₂O)ₓ—SiMe₃ where x=1, 2, 3, 4 or 5.

8. The process according to claim 1, wherein the auxiliary base simultaneously functions as a nucleophilic catalyst for the siloxylation.

9. The process according to claim 8, wherein the auxiliary base is 1-methylimidazole, 1-ethylimidazole, 1-n-butylimidazole, 2-methylpyridine or 2-ethylpyridine.

10. The process according to claim 1, wherein at least one mole of auxiliary base is used per mole of hydrogen halide to be removed.

11. The process according to claim 10, wherein the salt of the auxiliary base has a solubility of less than 20% by weight in the siloxy carboxylate or in the solution of the siloxy carboxylate in a suitable solvent.

12. The process according to claim 1, wherein the C₂-C₁₀-monocarboxylic acid and the auxiliary base are initially charged at least partly in a reactor and then the halosiloxane is metered in.

13. The process according to claim 1, wherein the monocarboxylic acid and the auxiliary base are initially charged at least partly in a reactor and then the halosiloxane is metered in.

14. The process according to claim 1, wherein the monocarboxylic acid is used in an amount of 1 to 2 equivalents, based on the amount of halosiloxane.
